(19) United States
(12) Patent Application Publication
(10) Pub. No.: US 2005/0131800 A1
(43) Pub. Date: Jun. 16, 2005

(54) Double blind electronic bidding system

(76) Inventors: John D. Parks, Redlands, CA (US); William L. Seiber, Riverside, CA (US); Bruce W. Pike, Highland, CA (US); David Basnett, Riverside, CA (US)

Correspondence Address: MAYER, BROWN, ROWE & MAW LLP, 190 SOUTH LASALLE ST, CHICAGO, IL, 60603-3441, US

(21) Appl. No.: 11/009,245

(22) Filed: Dec. 10, 2004

Related U.S. Application Data
(60) Provisional application No. 60/529,429, filed on Dec. 11, 2003.

(51) Int. Cl. G06F 17/60

(52) U.S. Cl. 705/37

(57) ABSTRACT

A system for facilitating the bidding process to include a single computer portal is provided. The invention includes the use of a computer network system that can include modules that have the ability to analyze and process information unique to customers, contractors, and vendors associated with the bidding process on a multi-department level. The invention further provides for monitoring the progress of an accepted bid. A method for facilitating the bidding process is also provided.

This application claims priority of U.S. provisional application Ser. No. 60/529,429 filed Dec. 11, 2003 incorporated herein by reference.

### FIELD OF THE INVENTION

The present invention relates to a method of effectively and efficiently managing the bidding and procurement of inter and intra-governmental and private sector agencies. More specifically, the invention relates to the field of bidding and procurement in which multi-component agencies can utilize a single computer assisted method to handle its entire bidding and procurement process, while maintaining complete control and accountability of their requests.

### BACKGROUND OF THE INVENTION

The governmental contract process, both state and federal, is complicated and often confusing even to those who are best informed on the subject matter. The bidding procedures and protocols require astute attention to minute detail as well as an in-depth knowledge of all applicable laws and regulations, which can vary substantially from government agency to government-agency and municipality to municipality. However, once the bidding process is over, the difficult task of oversight and monitoring the entire project and its concomitant expenditures can be in and of itself a rather Herculean effort, with budget constraints to work within, deadlines to meet, and last-minute changes. Further, it is not uncommon for long-term projects to receive short shrift by government officials especially when such a project straddles the election cycle and change of leadership occurs.

The complex nature of handling the bidding and procurement for multi-department agencies manifests itself in several ways. Typically, a multi-department agency uses a manual system or generic Internet portal that is compartmentalized by management and sub-systems. Using these systems to track and monitor bids and a project's progress can prove unworkable. For example, a city municipality is composed of many distinct departments, wherein each performs one or more distinct functions. It has management to control and manage the different departments, a public works department for infrastructure development and maintenance, parks and recreation department for public common use areas, utilities for power, water, and waste. With independent departments comes independent bidding and procurement process that management must maintain and control. The incorporation of all these systems and sub-systems for bidding and procurement creates an uncontrollable and complex system with little accountability and control, and hence, fiscal waste.

Therefore, a key goal for any single portal bidding and procurement software as provided by embodiments of the disclosed invention, is to standardize and create tools for management to monitor and coordinate all the requests made by the different departments within a single agency. Thus, the use of such a highly fragmented protocol for bidding and procurement system is unreliable. Without a standardized system, bidding and procurement requests are much more time consuming and expensive. However, as stated above, the efficiency of a standardized electronic bidding and procurement system is a viable option in the complex departmentalized agency. At present, agencies where electronic bidding is in use produces a substantial decrease in human resources and an increased savings with simplified results.

When dealing with multi-department agencies a second key element to ensure efficient operation of the overall process is information integration. One reason for this is that the spectrum of bidding vendors and contractors providing relevant service may be quite extensive. Integrated information systems provide a relatively cost-effective way to coordinate all the members of an agency's service and supply chain within any given tier and across the tier boundaries.

A second reason for the need to integrate information management of multi-department agencies into an electronic bidding and procurement system efficiently is the prevailing uncertainty inherent in the bidding and procurement process. The source of uncertainty is based on the multi-department agencies, contractors, and vendors, in the supply chain parlance, not knowing what the full scope of the project and details, and the inability to efficiently communicate with other departments, contractors, and vendors involved for a finished product. Information management is the key to permit all parties involved (i.e., agencies, contractors, vendors, administrators, and management) to communicate with each other efficiently and continuously, and thus anticipate and update budgets, labor, and supply accordingly.

Although the relevant prior art shows computer-assisted methods directed toward the bidding processes, none use, for example, a single portal to track on-going bidding process in a real time basis, and none have used this single portal to likewise track the progress of these projects.

Thus, there is a need for a single portal computer networked system which can facilitate and effectuate the bidding process with respect to governmental projects and procurements. There is further need for a single portal computer networked system to monitor the progress of the numerous projects once a winning bid is accepted. The need also exists for a single portal computer system to allow for the procurement of materials that are depleted during the course of completing a project on an as needed basis, without the build-up of costly unused inventory.

Embodiments of the present invention overcome the problems of overseeing governmental multi-department bidding processes and monitoring the project as it progresses by using a single portal computer system. Electronic bidding and procurement allows agencies desiring to acquire a product or service to utilize a customized electronic single portal system. It is a system that provides the desired results of a single entry multi contact interface. The complete bidding and procurement is made possible in large part by recent advances in various aspects of digital technology and e-commerce. An electronic bidding and procurement system can be adapted to serve the needs of distinct agencies, ranging in size from a small business to an entire country (as opposed to a single department). Accordingly, bidding and procurement websites are being applied to many industries and products, but have systemic limitations. Some of the agencies using bidding portals are municipalities, states, and federal organizations. There is however, a need for an Internet based method that provides multi-department agencies an accountable, effective and efficient system. The disclosed invention here addresses those needs. Specifically, one of the methods disclosed herein is the use of a Double Blind Electronic Bidding System (“DBS”) embodied in an Internet based process designed for any private or public agency to effectively and efficiently manage multiple departments. Although the invention will prove most ubiquitous in a governmental setting, the invention is readily applicable to private industry.

One of the keys of embodiments of the invention is the use of a single portal computer system that allows the agency or customer to communicate with the contractor or vendor in an anonymous manner during the bidding process. Subsequent to the bidding process, the single portal computer system allows for the centralization of monitoring the bidding process and progress of on-going projects not just in a single department, but in numerous departments. Another key of the invention is the use of a planning and viewing rooms which assist both the customer and contractor in deciding not only what the project is directed towards, but what materials are necessary to complete the project. The use of these rooms along with the DBS completes the communications' loop between the customer and contractor.

### SUMMARY OF THE INVENTION

The present invention is directed to a computer-assisted method of facilitating the bidding and procurement process, as well as the monitoring of accepted projects in the government and private having multi-department agencies. One embodiment of the invention consists of an Internet based system, referred to herein as DBS, that enables these agencies, contractors and/or vendors to bid on and monitor the progress of projects. The term “suppliers” refers to contractors and/or vendors. Using standard Web site based technology, the DBS system and concomitant software applications create a window-based single portal that acts as the communications hub between the customer and the contractor and allows the review of all on-going projects. The application is accessed through the Internet to licensed users and is designed for all bidding and procurement to be completed electronically making efficient connectivity between the governmental or private entity. The “suppliers” can be all potential contractors and vendors who must register with the licensing agency (i.e., governmental agency) to receive bids for that agency which, among other things, ensures the proper licensing and qualifications of the applicants—this creates an intranet forum in which to conduct business. Once all contractors and vendors are registered, those contractors and vendors receive notice of need of any bids that need to be filled. The notice provides all the particulars of a bid, e.g., time, dates, scope of work or product, performance bond requirements, dates of bid close date, contact information, etc. Further, the customer and suppliers have access to a planning room which displays specifications (e.g., materials, blueprints) required to complete a project, thereby expediting the bidding process.

When a request is received by the contractor or vendor, a job or reference number is associated with it, which is used during the entire bidding process. The name of the entity responding to the request remain anonymous which prevents any favoritism and levels the playing field promoting equal opportunity at winning a bid. Once a qualified bid has been selected by the customer, the details of the winning bid will be revealed instantly. DBS also notifies the non-selected companies of the customer's decision and the selection reasons.

Further, the method provides for high levels of agency input that is virtually non-existent in the bidding and procurement process when it comes to multi-component agencies in the public and private sectors. In addition, the process can be just as easily applied to situations where the customer merely wants to have renovation services performed on existing projects, rather than completely create a new one. The method therefore is adaptable for serving users of varying needs and financial resources.

Finally, DBS allows for management of the governmental or private entity to pull accurate real time reports for all the different departments and their budget for accounting purposes. However, the management is not allowed to input any information during the bidding process or monitoring phase of the project thus ensuring the procedure's integrity.

It is an object of the invention to provide a computer-assisted method for the bidding and procurement of agencies that are modular in design, wherein a customer has selected the modules of the system employed in the final multi-department agency. The method allows for a customer to choose components and assess the components' desirability using a planning room displaying the desired images in a digital format.

It is another object of the invention to provide a computer database that catalogues the multi-departments contractors and vendors. The data stored therein may include, but not be limited to, bidders' specialty trade and principal place of business, and the necessary building materials and supplies. Such data may be used in constructing the complete model for the customer's requested design to show how the components/modules are integrated. The database may also include other data relating to the availability and cost of item or service, the timelines involved for the service or items to be delivered or constructed, and the finished dates, etc.

It is still another object of this invention to provide a method of organizing a multi-department agency, wherein the vendors, service suppliers, and customers all communicate with each other within the scope of the project. The data stored herein may include, but is not limited to, request data, vendor qualifications, contractor license and qualifications, request history and timelines to indicate where in the multi-department agency this data is utilized. Such data may be used in constructing the modular model for the agency's customized needs, to show how all the modules will interact. The database may also include data relating to the cost, service provider cost and available timelines.

It is another object of this invention to provide a computer-assisted method of assembling a multi-department agency, wherein the vendors, contractors, and customers of the project communicate with each other for the duration of the project or request within the agency. Thus, the immediate vendors and contractors registered (i.e., Tier 1 vendors) and those that supply Tier 1 vendors (i.e., Tier 2 vendors), and so forth, all are integrated by a computer network. The computer network allows all registered users to discuss issues concerning, for example, costs of raw materials or components, and time frames required for the project completion specific to the contractors including all vendors. Such data may also be used by members of the supply chain to update and adjust inventories, based on consumer demands for specific items.

Another specific feature and object of the inventive computer-assisted method is to provide a method whereby the present requesting multi-department agency may have any new or rehabilitation project completed. In this scenario, the customer may use the inventive method to modify one or more requests simultaneously and in a real time basis, such that the bidder is also apprised of any modifications in a real-time basis. Alternatively, the customer may work any volume of job-requests and requested items simultaneously. If this is the goal, the customer may use the customized modular system and add or replace modules as needed.

Other specific features of the disclosed invention include:

A computer-assisted method for facilitating the bidding process for multi-component agencies, comprising the steps of registering one or more customers within a computer network wherein information unique to each of said customers is stored within said computer network; registering one or more suppliers within said computer network wherein information unique to each of said supplier is stored within said computer network; receiving one or more bids from one or more of said customers and storing information unique to each of one or more said bids within said computer network; querying a database to determine one or more qualified suppliers for said bid; notifying one or more said qualified suppliers of at least one of said bid via said computer network; displaying each of one or more bids to said at least one said qualified supplier via said computer network; receiving at least one response to one or more of said bids from one or more said qualified suppliers; accepting at least one of said responses to said bid via said computer network; notifying one of the qualified suppliers of the acceptance of the bid via said computer network.

An apparatus for facilitating a bidding process for multi-component agencies, comprising computer storage means for storing information unique to a customer within a computer network; means for storing information unique to a supplier within said computer network; means for storing information unique to a bid within said computer network; means for querying a database within said computer network to determine the most qualified supplier; means for notifying said supplier within information unique to said bid via said computer network; means for displaying information unique to said bid via said computer network; means for accepting responses to said bid via said computer network; means for notifying a most qualified supplier of acceptance of said bid via said computer network.

An apparatus for facilitating a bidding process for multi-component agencies, comprising: a centralized host computer network configured to facilitate a single portal computer system between at least one customer and at least one supplier;
a communication link between said centralized host computer network and a remote host computer allowing data transfer therebetween, wherein said centralized host computer network further comprises: at least one server residing on said centralized computer network for handling data transfer within said centralized computer network; at least one database accessible by said server for storing information unique to a customer and supplier; at least one module residing on said server configured to receive requests for bids or requests for proposals from said customer, process templated requests for bids or requests for proposals, receive a response to said requests from the supplier, querying said database for said response to determine the most qualified supplier, notify the supplier of an acceptance of said response, create a security system to protect the integrity of the module, and monitor the progress of an ongoing project on a real-time basis; at least one planning room generated by said centralized host computer network for displaying bid requirements accessible by said customer and supplier; a human interface server for providing on-going consultation to said customer or supplier on a real-time basis during a bidding cycle; and
human interface server means for handling input from, and output to, an end-user.

A system for facilitating the bidding process, comprising: a customer module for generating bids and awards contracts associated with at least one bid; a contractor module for allowing prospective and qualified contractors vendors access to respond to said bid; and a vendor module for allowing prospective and qualified vendors access to respond to said bid.

A method of facilitating the acceptance of bid and awarding contracts associated with said bid comprising: under the control of a computer network, storing information unique to at least one customer and at least one supplier; populating a database with at least one qualified supplier; allowing for said customer to generate bids and award contracts associated with said bids, customize said computer network to meet said customer's individual organizational structure, provide a point and click system for templated bid requests, monitor the progress of a project associated with said bid, and real time access to individual project reports; allowing said supplier to customize said computer network to meet said supplier's individual organizational structure, provides a point and click system for submitting templated bids, receive notification of said bids, and submit said response to said bid; allowing said vendor to customize a computer network to meet a vendor's individual organization structure, provide a point and click system for submitting templated bids, receive notification of said bids, and submit said response to said bid; creating a single computer portal to be use by said customer and said supplier to facilitate said bidding process; receiving a bid from said customer; creating a planning room displaying the requirements of said bid;
querying said database for at least one qualified supplier; notifying at least one of said qualified suppliers of said bid; receiving a response from said qualified suppliers;
querying said database to rank said responses; accepting a response to said bid from at least one of said qualified suppliers; and notifying said suppliers at least one of said qualified bid of acceptance.

The general approach to this computer-assisted method of multi-department agency single inter-face system is described for standardizing the bidding and procurement process. However, it should be clear that agencies, vendors, and contractors with minimal computer skills could adapt this system without making any significant changes.

### BRIEF DESCRIPTION OF THE DRAWINGS

FIG. 1 is a diagram illustrating a typical centralized host computer network.

FIG. 2 is a block diagram of the Customer Module.

FIG. 3 is the functional flow chart of the bid cycle sub-module for the Customer Module.

FIG. 4 is the functional flow chart of the project management sub-module for the Customer Module.

FIG. 5 is a block diagram of the Contractor Module.

FIG. 6 is the functional flow chart of the bid cycle sub-module for the Contractor Module.

FIG. 7 is the functional flow chart of the project management sub-module for the Contractor Module.

FIG. 8 is a block diagram of the Vendor Module.

FIG. 9 is the functional flow chart of the bid cycle sub-module for the Vendor Module.

FIG. 10 is the functional flow chart of the project management sub module for the Vendor Module.

FIG. 11 illustrates a typical functional flow diagram of the configuration of the centralized host computer network set forth in FIG. 1.

FIG. 12 illustrates an example of a template for customer registration forms.

FIGS. 13a and 13b illustrate an example of a template for supplier registration forms.

FIGS. 14a and 14b illustrates an example of template for a bid submission form.

FIG. 15 illustrates a planning room display.

FIG. 16 illustrates an example of a completed bid template.

FIG. 17 illustrates a typical notification sent to losing suppliers.

### DETAILED DESCRIPTION OF THE INVENTION

A preferred embodiment of the inventive method will be described with respect to a computer assisted method to facilitate and automate the bidding and procurement process of multi-department agencies. It will be well understood by those having ordinary skill in the relevant art that the inventive method can be modified to meet the expansion or decrease of other multi-department agencies, without significantly departing from the invention described herein.

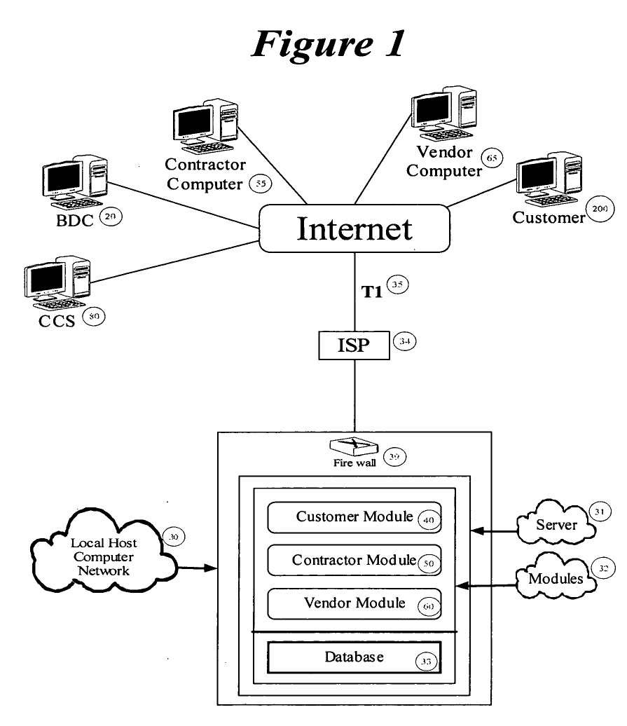

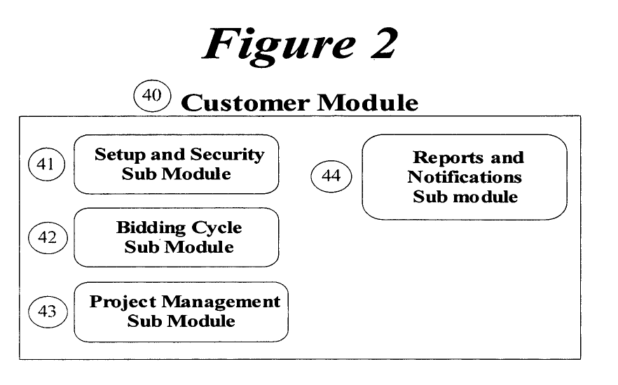

Turning to a preferred embodiment of the invention, FIG. 1 illustrates a typical configuration of DBS. The computer based components of the DBS configuration consists of a local host computer network 30, at least one secure server 31, various modules 32, at least one database 33, wherein the local host computer network 30 is connected to the Internet using an Internet Service Provider (ISP) 34 via any known suitable communications link 35, e.g., T1 or T3 line. The details and means by which the local host computer network 30 and any remote host computer networks communicate with the Internet are not essential nor necessary to understanding the present invention. The DBS configuration further comprises a Business Development Component 70 and a Continuous Customer Support Component 80—these two components are integrated throughout the DBS system.

As for the computer-based components of the DBS system, the hardware platform for the server 31 can be any type of server hardware platform suitable in handling database and information processing in a Web based environment (e.g., Microsoft SQL Server 6.5), while the underlying server 31 operating system software can be one of the many commercially available systems produced by commercially available software vendors such as Microsoft or Apple. The local host computer network 30 could also include the a firewall 37 (e.g., Secure Socket Layer) for security purposes.

Contained within the server 31 are modules 32 resident on a suitable Web server. These modules 32 make up the software platform of the host computer network 30 that executes the essential tasks in order to handle requests for bids or requests for proposals (collectively, RFP/RFB) from inception to final billing. DBS' software is delivered in an Application Service Provider (ASP) format that relieves the end-user from the burden of managing additional hardware and software infrastructures. Since DBS is Internet based, its software applications need not be downloaded on every user's computer terminal—rather, all that is needed to access the application is Internet connectivity, password, or code and a suitable web browser, or any HTML enabled browser installed on the user's computer. DBS's software platform can be implemented using any suitable computer languages, such as the higher programming languages of C++ or Java. By hosting the software on the server 31, the disclosed process can be accessed anywhere, anytime, at the user's request via the Internet. The DBS system in whole or in part can be limited to specific Internet protocols or open to the entire world depending on need.

The DBS software platform comprises three base modules: the Customer Module 40, the Contractor module 50, and the Vendor Module 60. Each of the modules consists of several sub modules, which address specific needs and requirements from each user of the DBS configuration. Additionally, the modules 32 will have access to the database 33 and the information residing therein to use in executing and completing their respective tasks.

DBS Software Platform

The highly scalable software residing in the various modules 32 offer diverse function as using uniquely tailored RFP/RFB templates, single entry/multi-contact auto-notification to all qualified contractors or vendors, automated receipts at completion of a particular project or receipt of goods, through an audit trail ensuring accountability at all levels.

Customer Module

The Customer Module 40 generates the bids and awards the contracts associated with bidding and procurement. The Customer module preferably consists of four sub-modules, which allow the Customer to manage their entire individual, or collective, bidding, and procurement cycle under a standardized and simple to use system. The Customer Module brings a new level of efficiency and transparency to the Customer's organization, which results in a substantial savings realized within each action associated with the bidding and procurement cycle.

Set-up and Security Sub-Module 41. This sub-module allows for each individual customer (e.g., governmental agency or corporation) to customize their DBS network to meet their individual organizational structure, including management levels, departments, and branch offices, regardless of size or geographic location. It also allows the licensing entity to set individual and department access levels in the system, thereby ensuring maximum effectiveness of the integrity of the system and provides an automated shield to protect from malfeasance within the bidding and procurement cycle. This sub-module 41 also tracks and documents every action occurring within the DBS network, for future reference and support of the reports and notifications sub-module.

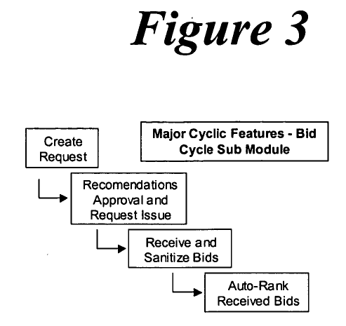

Bid Cycle Sub-Module 42. This sub-module provides a “point and click” or “fill in the blank” system for templated requests for bid or proposal packages. As the flow diagram depicted in FIG. 3 illustrates, this module 42 encompasses the entire request cycle, from inception to recommendation and approval for issue routing sequences in order to sanitize electronic storage or received bids through automated ranking of bids received during public or private opening of bids received. This module allows the DBS to be utilized as an effective tool to enforce current bidding and procurement policies, by its easily customized process features. The sub-module also consists of all editing or administrative requirements in conjunction with the bidding process.

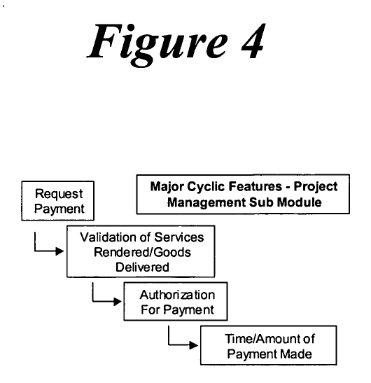

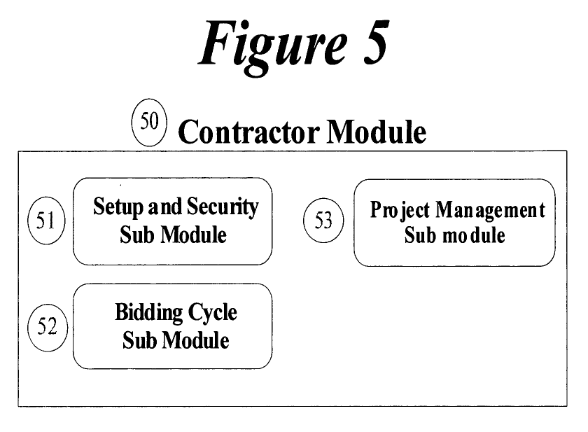

Project Management Sub Module 43. This module ensures timely, milestone completion of contracted work, and timely delivery and accountability of goods or services. As the flow diagram depicted in FIG. 4 illustrates, this module 44 allows the Customer to effectively monitor not only the progress of an individual project, but also track timelines, quantities of delivered goods, and budget items to ensure proper and timely payment is made. It automates the extremely labor intensive and mistake prone manual systems, which costs agencies and organizations billions of dollars annually in over payments. This module automates the request for inspection and request for payment cycles and allows the Customer to respond to automated requests for inspections of milestones or requests for payment with documented proof of services rendered or goods delivered, prior to payment being made. It encompasses the decision making cycle for payment, to validation of services rendered or goods delivered, to approval for issue of payment, through payment made. This sub-module utilizes a milestone and delivery, invoicing template to maximize in integrity of the payment cycle, while minimizing over or duplicate payments.

Reports and Notifications Sub-Module 44. The reports section allows real time access to individual project reports for any time period requested and is easily customized to meet the needs of the Customer. While the reports section provide a vital real time link to information, and an accurate report of current actions, the notifications section provides an early warning notification to managers of possible or potential irregularities. The notification section is designed as an auto-message system, notifying key individuals of actions occurring or actions failing to occur as anticipated, providing an immediate information flow to ensure all contracted goods or services are completed or delivered as efficiently as possible. The notification section is also easily customizable to meet the exact needs of the Customer.

Contractor Module 50 allows prospective and qualified contractors to gain access to the bidding process. The contractor module preferably consists of three sub modules, which bring a simple, but, complete bidding management system to the contractor using the DBS configuration. Qualified contractors 55 can access the local host computer network 30 via the Internet using any suitable computer downloaded with the requisite DBS software.

Set-up and Security Sub module 51. The set-up and security sub module allows each individual contractor 55 using the DBS to customize their DBS system to meet their individual organizational structure including management levels, departments and branch offices, regardless of size. It also allows contractor to set individual and departmental access levels in the system ensuring maximum effectiveness of the integrity of the system and provides an automated shield to protect from malfeasance within the bidding cycle. This module also tracks and documents 100% of all actions occurring within the DBS for future reference and support of the reports and notifications sub module. This sub module is a mirror of the Customer set-up and security sub module.

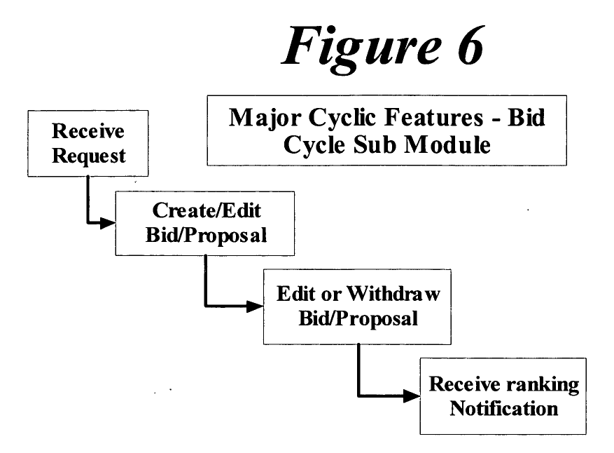

Bid Cycle Sub Module 52. The bid cycle sub module is the core module in the relation to the bidding and procurement cycle; it provides an automated solution to the current labor and time intensive manual bidding cycles. This module provides a point, click, or fill in the blank system for submitting (including responses thereto) templated bid or proposal packages. As the flow diagram depicted in FIG. 6 illustrates, this module 52 encompasses the entire bidding cycle, from receiving notification of inviting bids, to creating and submitting a bid, through auto-notification of ranking after public opening of bids. This sub module also consists of all editing or administrative requirements in conjunction with the bidding process, for the contractor.

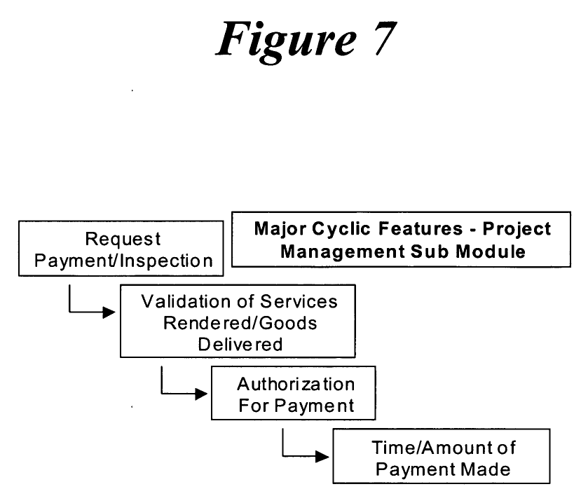

Project Management Sub Module 53. The project management sub module is the core module in ensuring timely inspections, and payments are completed or received for services rendered. It automates the request system for either required inspections or payment for milestones completes. As the flow diagram depicted in FIG. 7 illustrates, this module 53 allows a point, click, or fill in the blank request, which relays the information required for actions immediately to the Customer. This module also includes automated reports on current projects, or gives several information roll-up options.

Vendor Module 60 allows prospective and qualified vendors to gain access to the bidding process. The vendor module preferably consists of three sub modules, which bring a simple, but, complete bidding management system to the vendor. Qualified vendors 65 can access the local host computer network 30 via the Internet using any suitable computer downloaded with the requisite DBS software.

Set-up and Security Sub Module 61. The set-up and security sub module allows each individual vendor 65 organization using the DBS to customize their DBS system to meet their individual organizational structure including management levels, departments and branch offices, regardless of size. It also allows vendor to set individual and departmental access levels in the system. This ensures maximum effectiveness of the integrity of the system and provides an automated shield to protect from malfeasance within the bidding cycle. This module also tracks and documents 100% of all actions occurring within the DBS, for future reference and support of the reports and notifications sub module. This sub module is a mirror of the Customer and contractor set-up and security sub module.

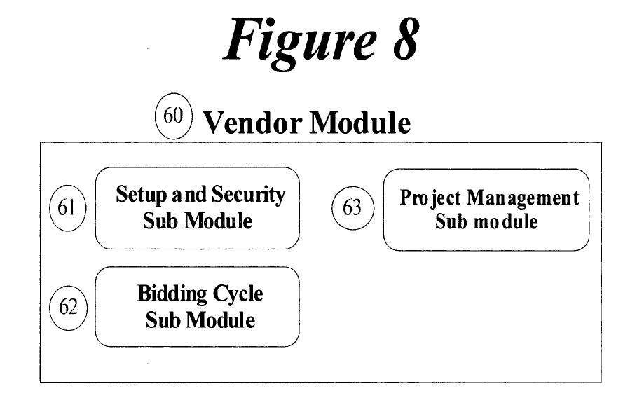

Bid Cycle Sub Module 62. The bid cycle sub module is the core module in the relation to the bidding and procurement cycle; it provides an automated solution to the current labor and time intensive manual bidding cycles. As the flow diagram depicted in FIG. 8 illustrates, this module provides a point, click, or fill in the blank system for submitting templated bid or proposal packages. It encompasses the entire bidding cycle, from receiving notification of inviting bids, to creating and submitting a bid, through auto-notification of ranking after public opening of bids. This sub module also consists of all editing or administrative requirements in conjunction with the bidding process, for the vendor. This sub module is a mirror of the contractors bid cycle sub module.

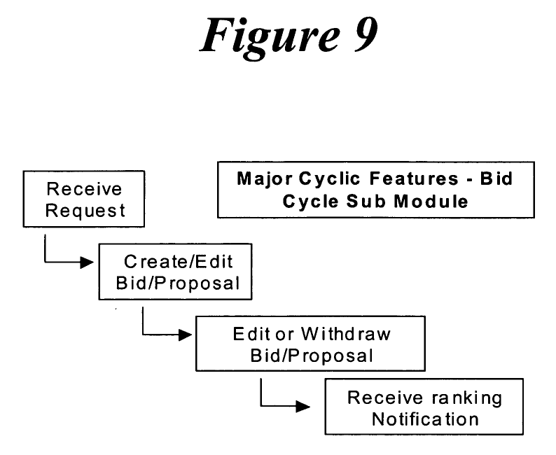

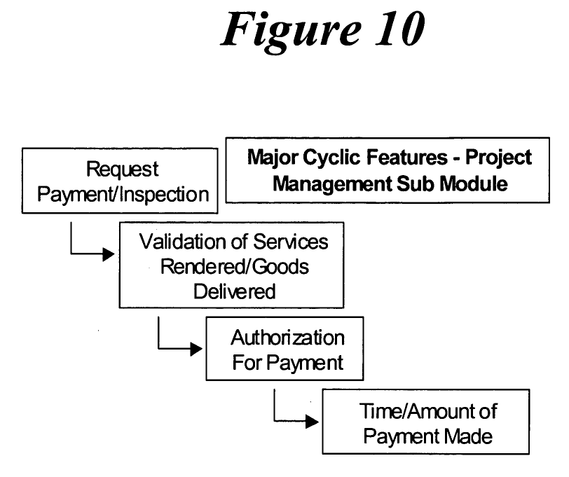

Project Management Sub Module 63. The project management sub module is the core module in ensuring timely inspections, and payments are completed or received for services rendered. It automates the request system for either required inspections or payment for milestones completed. As the flow diagram depicted in FIG. 9 illustrates, this sub module allows a point, click, or fill in the block request, which relays the information required for action immediately to the Customer. This sub module for the vendors also includes automated reports on current projects, or gives several information roll-up options. This sub module is also a mirror of the contractor project management sub module.

Business Development Centers (BDCs) 70. One of the greatest challenges to automation is end user access and training. The end user is a critical element in the success of any system or solution, and while most organizations focus primarily on the Customer, the DBS configurations includes physical locations, which provide both end user access and systems training. This is a critical element to ensure a smooth transition from a manual system to an automated system. This also ensures critical buy-in from the end-users that build out and staffs local facilities “Business Development Centers,” which house plans viewing rooms, reprographic centers, Internet stations for accessing and responding to RFP/RFBs, hiring centers, and training locations. Included in the Business Development Centers are dedicated staff to support the transition for the end user and to establish a positive image for HHB and the Customer within each community. As shown in FIG. 1, the BDCs have at least one computer connected to the local host computer 30 communications link 35 allowing it access to the DBS configuration. Further, the BDC may also consist of customer continuous support. The DBS configuration includes immediate and dedicated telephone and web support to ensure the system provides the maximum return of investment for all projects and purchases. Ongoing consultation, and training and system upgrades, ensures that the system remains up-to-date and core to the bidding and procurement process. As shown in FIG. 1, the CCS would have at least one computer connected to the local host computer 30 communications link 35 allowing it access to the DBS configuration.

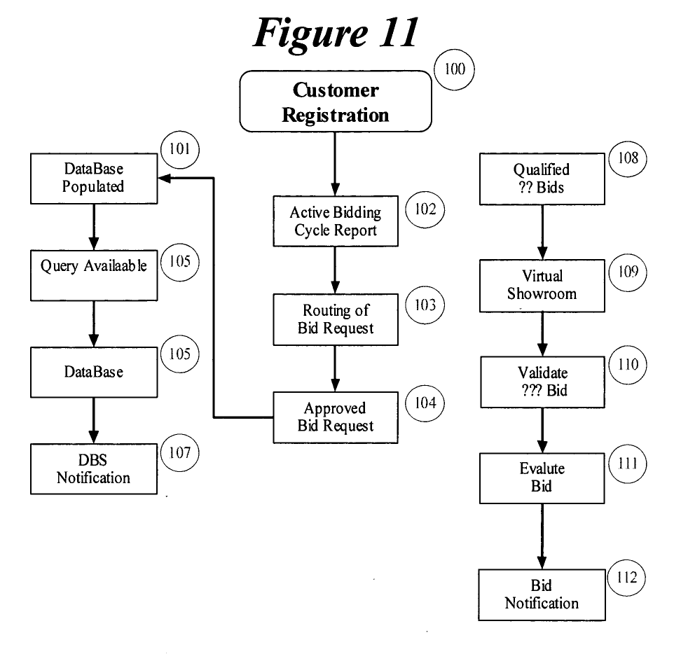

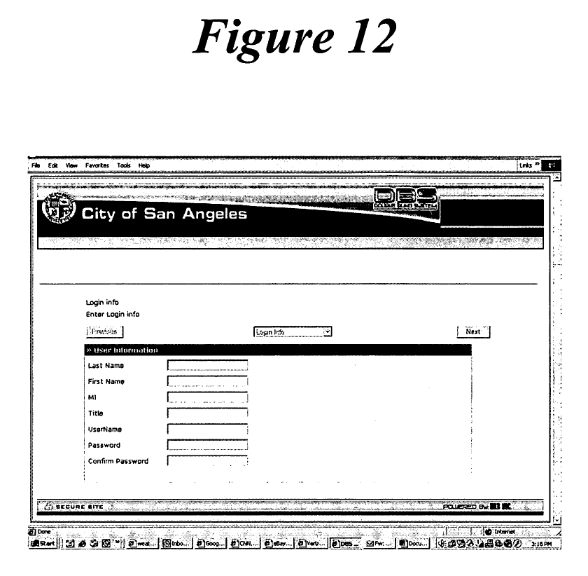

FIG. 11 illustrates a typical functional flow diagram of the configuration of the centralized host network set forth in FIG. 1. The initial step 100 in the procurement cycle is customer registration the DBS system. The registration is relatively straightforward with the customers completing a templated registration form like the one illustrated by FIG. 12. The registration can be completed online or in hard copy format with the information being entered manually with the centralized host computer network and downloaded into the customer database. Once a customer 200 registers, it is granted access to the DBS network and provided a password or passcode or some similar security mechanism to protect the integrity of its data.

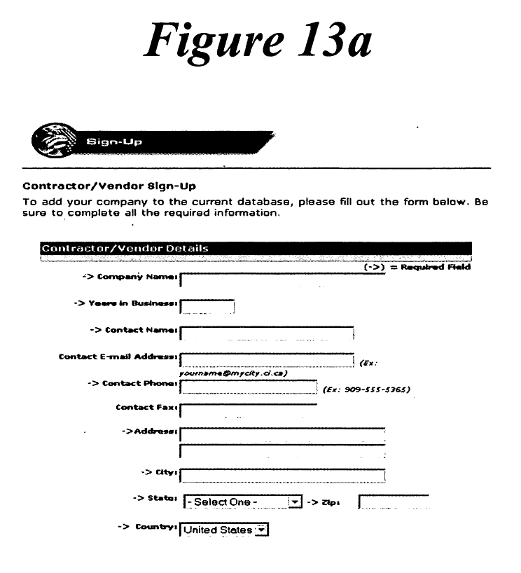

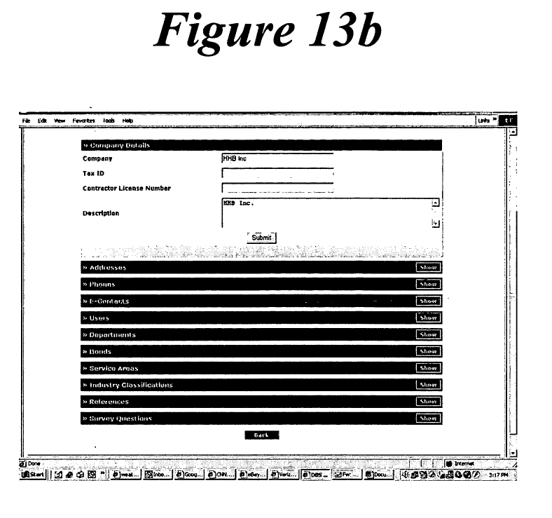

Next, as indicated by step 101 in FIG. 11, the database 33 is populated with potential contractors 55 and vendors 65. Depending on when customer is registered, the database 33 may already contain registered and qualified contractors and vendors from a previous registration process. Regardless, the process for registering a contractor or vendor to that of the customer's—it can be completed on line or via hard copy, and is subsequently downloaded into the bidder database. An illustrative copy of the templated registration form is shown in FIGS. 13a and 13b. Once registration is complete, the contractor and vendor are provided with a unique password or passcode or some similar security mechanism to protect the integrity of its data, and is granted access to the network.

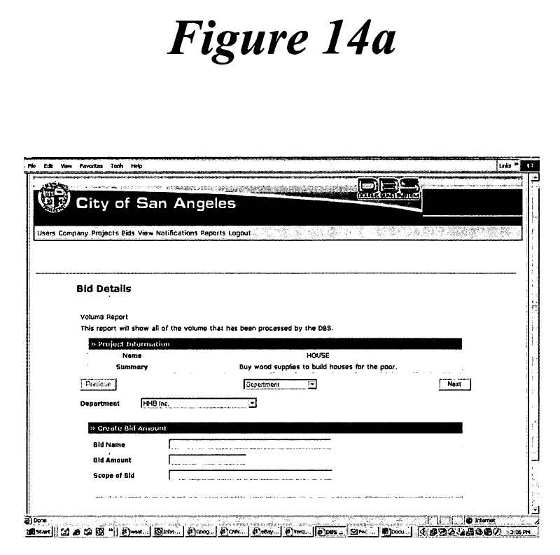

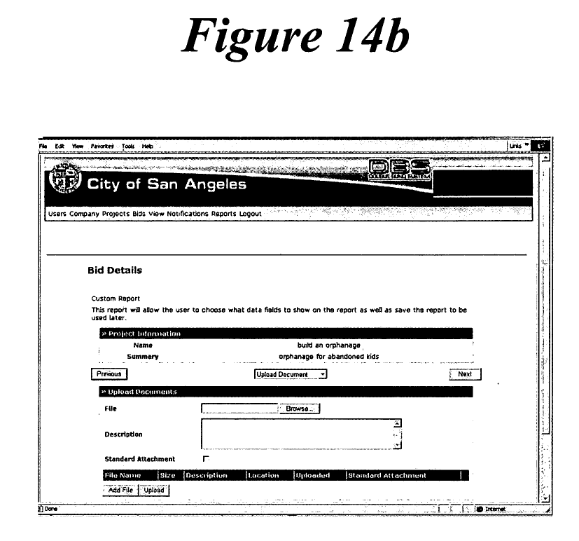

Upon registration, the customer begins requesting competitive bids on requisition of goods or services, such as a construction/professional services or materials and supplies. The customer desiring to fulfill a bid may scan the database 33 looking for the proper profile from among those that the contractors and vendors fit in the request. The active bidding cycle begins at step 102 with the customer completing a templated, electronic request setting forth a detailed job description or a request for goods among other things. FIGS. 14a and 14b depicts a typical bid submission form. This form can be tailored to meet the unique needs of a customer and can be readily modified. The bid information contains all the information relevant to the bid to include, but not be limited to, the job description, time frame, location, special instructions, and all requirements required by existing laws and/or policy. Once completed, the request is electronically routed through a multi-level, issue approval sequence at step 103. This sequence allows for documentation and decisions, to include funding requirements on any recommended adjustments to the request, prior to issuance to the public.

Upon approval, the request is electronically submitted through a single input/multi-output feature to the database 33 at step 104. When a customer's series of requests are finalized, each datum related to that request is processed. Next, at step 105 the database 33 will immediately query all available contractor's and vendor's qualifications and job size that reflect the last series of choices made by a customer. At step 106, the database 33 containing the contractor and vendor information will then be populated with qualified candidates for that specific bid. At step 107, DBS will then notify (e.g., fax or e-mail) the qualified contractors and vendors of the request for bid or request for proposal.

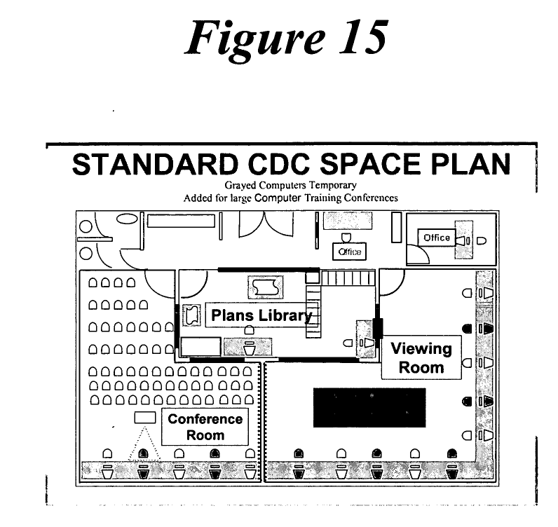

Then, at step 108, the qualified contractors and vendors prepare their respective bids or proposals using a planning room provided for by DBS. During the population of the customer and bidder databases, and the submission for a request for a bid, a planning room is created at step 109 using the database information. The planning room depicts the materials and supplies needed for the project, specifications, and blueprints, and creates a forum where the qualified bidders and requesting customers could inquire further about the project. For example, during the course of a project, a customer may desire to use a different material or item. Once the item is selected, the system will automatically activate the planning room. Alternatively, the planning room feature may be activated independently. The planning room will produce scanned photographs of the chosen items as they are combined into the consumer's customized requests. The customer may begin with the make and model so as to define the generalized nature of the chosen request, prior to inspection for purchase. FIG. 15 illustrates a typical planning room. Qualified contractors and vendors would be able to review and access all relevant information including the ability to review as needed using the Web based software application. Alternatively, the database will feed all choice-related information into a computer network to which all members of the contractor and vendor's supply chain have access. Once a project begins, the database containing information regarding the planning room will monitor the materials used and needed for the project. Should an item begin to deplete, the network will notify the appropriate customer and/or bidder. Thus, the re-order signal may be sent directly to the bidder's relevant suppliers at all tiers of the supply chain enabling all bidders to coordinate among themselves the most efficient means to satisfy the agency need, as reflected in the changes in inventory of the contractor vendor database. Another important function of the computer network is to provide data to registered users so that each user can better predict the market demand for various items and therefore adjust its inventories and/or servicing capabilities accordingly.

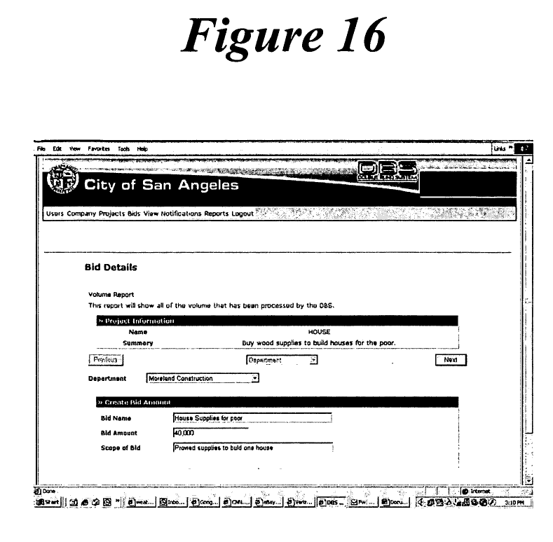

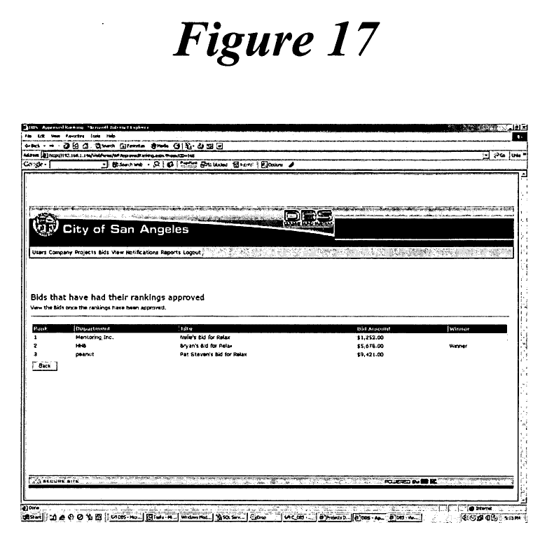

At step 110, a contractor or vendor completes and validates their templated bid package or proposal, which is then electronically sanitized to meet legal and/or policy requirements and stored as a submitted bid to the requesting agency. FIG. 16 illustrates a typical completed bid template. All bids received through DBS by the customer remain sanitized, e.g., appearing only as a random thirteen digit number, which cannot be opened until official public opening or as individual agency policy allows. At the appropriate time, all bids appear as files under request number and remain sanitized until parameters for ranking are input by the agency. At step 108, parameters for ranking the bids are inputted, and DBS automatically calculates and provides recommended rankings for the agency using an algorithm based on pre-selected factors (e.g., price, qualifications).

Once the final bid has been chosen, the chosen company is notified electronically at step 112. Losing bidders are notified of their ranking within the bids received, including the reasons why they were not chosen. At this juncture, actual bidding cycle is complete and the agency awards a contract to their selected winner. FIG. 16 illustrates a typical notification sent to those losing bidders.

From this point forward, the DBS network provides the agency with an Internet based project management/tracking feature for the life of the project. The management/tracking capability facilitates requests for inspections, validations of inspections, validations of goods, delivery of goods by location and quantity, requests for payment (invoicing) and recording of payment made—all through the local computer network 30. During the entire project cycle, from inception of an idea through final payment, the agency has full access to robust query, real-time, and multi-level reports. All reports are individual to the customer, providing multi-level access and allowing for critical decision-making utilizing “real time” data. The same request would also apply to a request for proposal for the contractor 55 or vendor 65, except it would only differ in that the scope of the request is not for service, but for products such as lumber, nails, etc., or anything that the agency may need. The request would be responded to in the same way to the requesting agency. The database may signal that the inventory of a specific item has dipped below a pre-determined level, and as a result, provides management with an indicator of a need to re-order.

While the present invention has been described in connection with preferred embodiments thereof, many modifications and variations will be apparent to those skilled in the art. Doubtless, other variations will be apparent to those skilled in the art.

1. A computer-assisted method for facilitating the bidding process for multi-component agencies, comprising the steps of:
registering one or more customers within a computer network wherein information unique to each of said customers is stored within said computer network;
registering one or more suppliers within said computer network wherein information unique to each of said supplier is stored within said computer network;
receiving one or more bids from one or more of said customers and storing information unique to each of one or more said bids within said computer network;
querying a database to determine one or more qualified suppliers for said bid;
notifying one or more said qualified suppliers of at least one of said bid via said computer network;
displaying each of one or more bids to said at least one said qualified supplier via said computer network;
receiving at least one response to one or more of said bids from one or more said qualified suppliers;
accepting at least one of said responses to said bid via said computer network;
notifying one of the qualified suppliers of the acceptance of the bid via said computer network.

2. The method of claim 1, wherein said customer is a governmental agency.

3. The method of claim 1, wherein said supplier is a contractor or vendor.

4. The method of claim 1, further comprising monitoring the progress of said accepted bid by recursively reviewing and updating said database for any changes in customer demand, inventory, or cost of supplies.

5. The method of claim 4, wherein said computer network recursively analyzes said database for information relating to the performance of said customer, the costs of purchasing and installing materials, and availability of said suppliers so as to provide updated delivery of goods or services to said customer.

6. The method of claim 1, wherein said bids are displayed in a planning room via said computer network.

7. The method claim 1, further comprising the step of coordinating delivery of goods or services of said accepted bid.

8. The method of claim 1, further comprising monitoring the progress of said accepted bid.

9. An apparatus for facilitating a bidding process for multi-component agencies, comprising:
computer storage means for storing information unique to a customer within a computer network;
means for storing information unique to a supplier within said computer network;
means for storing information unique to a bid within said computer network;
means for querying a database within said computer network to determine the most qualified supplier;
means for notifying said supplier within information unique to said bid via said computer network;
means for displaying information unique to said bid via said computer network;
means for accepting responses to said bid via said computer network;
means for notifying a most qualified supplier of acceptance of said bid via said computer network.

10. An apparatus for facilitating a bidding process for multi-component agencies, comprising:
a centralized host computer network configured to facilitate a single portal computer system between at least one customer and at least one supplier;
a communication link between said centralized host computer network and a remote host computer allowing data transfer therebetween,
wherein said centralized host computer network further comprises:
at least one server residing on said centralized computer network for handling data transfer within said centralized computer network;
at least one database accessible by said server for storing information unique to a customer and supplier;
at least one module residing on said server configured to receive requests for bids or requests for proposals from said customer, process templated requests for bids or requests for proposals, receive a response to said requests from the supplier, querying said database for said response to determine the most qualified supplier, notify the supplier of an acceptance of said response, create a security system to protect the integrity of the module, and monitor the progress of an ongoing project on a real-time basis;
at least one planning room generated by said centralized host computer network for displaying bid requirements accessible by said customer and supplier;
a human interface server for providing on-going consultation to said customer or supplier on a real-time basis during a bidding cycle; and
human interface server means for handling input from, and output to, an end-user.

11. A system for facilitating the bidding process, comprising:
a customer module for generating bids and awards contracts associated with at least one bid;
a contractor module for allowing prospective and qualified contractors vendors access to respond to said bid; and
a vendor module for allowing prospective and qualified vendors access to respond to said bid.

12. The system of claim 11, wherein said customer module further comprises of at least four sub-modules.

13. The system of claim 12, wherein a customer sub-module allows for a customer to customize their DBS network to meet their individual organizational structure, including management levels, departments, and branch offices.

14. The system of claim 12, wherein a customer sub-module provides a point-and-click or fill-in-the-blank system for templated requests for bids or proposal packages.

15. The system of claim 12, wherein a customer sub-module allows a customer to monitor the progress of said bidded work to ensure timely, milestone completion of bidded work, and timely delivery and accountability of goods or services.

16. The system of claim 12, wherein a customer sub-module allows real time access to individual project reports concerning the progress of said bidded work.

17. The system of claim 11, wherein said contactor module further comprises of at least three sub-modules.

18. The system of claim 17, wherein a contractor sub-module allows for a contractor to customize their DBS network to meet their individual organizational structure, including management levels, departments, and branch offices.

19. The system of claim 17, wherein a contractor sub-module provides a point-and-click or fill-in-the-blank system for submitting a response to templated requests for bids or proposal packages.

20. The system of claim 17, wherein a contractor sub-module allows a contractor to monitor the progress of said contractor work on a real time basis to ensure that payments are made in a timely manner for services rendered.

21. The system of claim 11, wherein said vendor module further comprises of at least three sub-modules.

22. The system of claim 21, wherein a vendor sub-module allows for a vendor to customize their DBS network to meet their individual organizational structure, including management levels, departments, and branch offices.

23. The system of claim 21, wherein a vendor sub-module provides a point-and-click or fill-in-the-blank system for submitting a response to templated requests for bids or proposal packages.

24. The system of claim 21, wherein a vendor sub-module allows a contractor to monitor the progress of said vendor work on a real time basis to ensure that payments are made in a timely manner for services rendered.

25. The system of claim 11, wherein a single portal is created allowing access to said customer module, contractor module, and vendor module.

26. A method of facilitating the acceptance of bid and awarding contracts associated with said bid comprising:
under the control of a computer network, storing information unique to at least one customer and at least one supplier;
populating a database with at least one qualified supplier;
allowing for said customer to generate bids and award contracts associated with said bids, customize said computer network to meet said customer's individual organizational structure, provide a point and click system for templated bid requests, monitor the progress of a project associated with said bid, and real time access to individual project reports;
allowing said supplier to customize said computer network to meet said supplier's individual organizational structure, provide a point and click system for submitting templated bids, receive notification of said bids, and submit said response to said bid;
allowing said vendor to customize a computer network to meet a vendor's individual organization structure, provides a point and click system for submitting templated bids, receive notification of said bids, and submit said response to said bid;
creating a single computer portal to be use by said customer and said supplier to facilitate said bidding process;
receiving a bid from said customer;
creating a planning room displaying the requirements of said bid;
querying said database for at least one qualified supplier;
notifying at least one of said qualified suppliers of said bid;
receiving a response from said qualified suppliers;
querying said database to rank said responses;
accepting a response to said bid from at least one of said qualified suppliers; and
notifying said suppliers at least one of said qualified bid of acceptance.
